(19) United States
(12) Patent Application Publication
(10) Pub. No.: US 2024/0377324 A1
(43) Pub. Date: Nov. 14, 2024

(54) FLUORESCENCE DETECTION VIA OUTCOUPLERS

(71) Applicant: Hewlett-Packard Development Company, L.P., Spring, TX (US)

(72) Inventors: Alexander Govyadinov, Corvallis, OR (US); Viktor Shkolnikov, Palo Alto, CA (US); Fausto D'Apuzzo, Palo Alto, CA (US)

(73) Assignee: Hewlett-Packard Development Company, L.P., Spring, TX (US)

(21) Appl. No.: 18/564,531

(22) PCT Filed: May 28, 2021
(86) PCT No.: PCT/US2021/034723

§ 371 Date: Nov. 27, 2023

(51) Int. Cl. G01N 21/64

(52) U.S. Cl. CPC G01N 21/6428; G01N 2021/6439; G01N 2201/0634

(57) ABSTRACT

In one example in accordance with the present disclosure, a fluorescence detection system is described. The fluorescence detection system includes a microfluidic chamber to receive a sample containing a compound to be detected. An illumination system provides an excitation light to excite fluorophores in the microfluidic chamber. An outcoupler is disposed between the illumination system and the microfluidic chamber to diffuse the excitation light to fill the microfluidic chamber. The fluorescence detection system also includes a detection system to detect fluorescence generated by the excitation of the fluorophores in the microfluidic chamber.

### BACKGROUND

Cellular biology is a field of biology that studies the structure, function, and operation of cells. An understanding of the structure, function, and operation of cells provides a wealth of information. For example, individual cells may be used to generate cell lines and to aide in the further understanding of mechanisms of cellular function. As another example, once the structure, function, and operation of cells is more fully understood, certain diseases may be prevented and treated.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluorescence detection system with an outcoupler, according to an example of the principles described herein.

FIG. 2 is a diagram of a fluorescence detection system with an outcoupler, according to an example of the principles described herein.

FIG. 3 is a flowchart of a method for detecting a compound via a fluorescence detection system with an outcoupler, according to an example of the principles described herein.

FIG. 4 is a diagram of a fluorescence detection system with an outcoupler, according to an example of the principles described herein.

FIG. 5 is a diagram of a fluorescence detection system with an outcoupler, according to an example of the principles described herein.

FIG. 6 is a diagram of a fluorescence detection system with an outcoupler, according to an example of the principles described herein.

FIG. 7 is a diagram of a fluorescence detection system with an outcoupler, according to an example of the principles described herein.

FIG. 8 is a diagram of a fluorescence detection system with an outcoupler, according to an example of the principles described herein.

FIG. 9 is a diagram of a fluorescence detection system with an outcoupler, according to an example of the principles described herein.

FIG. 10 is a diagram of a fluorescence detection system with an outcoupler, according to an example of the principles described herein.

FIG. 11 is a diagram of a fluorescence detection system with an outcoupler, according to an example of the principles described herein.

FIG. 12 is a diagram of a fluorescence detection system with an outcoupler, according to an example of the principles described herein.

FIG. 13 is a diagram of a fluorescence detection system with an outcoupler, according to an example of the principles described herein.

FIG. 14 is a diagram of a fluorescence detection system with an outcoupler, according to an example of the principles described herein.

FIGS. 15A and 15B are diagrams of a fluorescence detection system with an outcoupler, according to an example of the principles described herein.

FIGS. 16A and 16B are diagrams of a fluorescence detection system with an outcoupler, according to an example of the principles described herein.

FIG. 17 is a diagram of a fluorescence detection system with an outcoupler, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Cellular biology is a field of biology that studies the structure, function, and operation of cells. With an understanding of the structure, function, and operation of cells a variety of chemical reactions and processes can be carried out. For example, individual cells may be used to generate additional cells, genetic tests may be performed, and infection agents may be identified. A wealth of information can be collected from a cellular sample. A greater understanding of the different kinds of cells and their function can lead to certain technological innovations. For example, certain biologics such as proteins, insulin, other therapeutic drugs, ribonucleic acid (RNA), and deoxyribonucleic acid (DNA) may be obtained from cells.

In one particular example, scientists may conduct tests to identify certain compounds within a sample. For example, a compound within a sample may be used to diagnose a particular disease. As a specific example, the presence of certain antigens may be indicative that a patient suffers from a particular disease. With the diagnosis, a medical professional may work to combat the disease. To aide in the diagnosis, fluorescing particles may be attached to the antigens in a sample.

That is, optical fluorescence occurs when a molecule absorbs light at wavelengths within its absorption band, and then emits light at longer wavelengths within its emission band. For compound tracking, fluorescing molecules, referred to as fluorophores, may be attached to biological molecules and other targets of interest to enable identification, quantification, and even real-time observation of biological and chemical activity. Accordingly, by detecting the presence and quantity of excited fluorophores in a sample, a fluorescence detection system may determine the presence and quantity of certain antigens in the sample, and may thus provide a diagnosis based on a determined presence and quantity of the antigens.

While particular reference is made to a specific antibody antigen test, any number of tests may be carried out by identifying target compounds in a sample. Examples include the diagnosis of respiratory disease and an enzyme-linked immunosorbent (ELISA) assay which detects and quantifies peptides, proteins antibodies, and hormones. That is to say, there are a number of detection operations that may be used in the medical and chemical industries to identify compounds in a sample, which compounds may be used to diagnose diseases or carry out any number of other analytic operations.

While tracking fluorescence allows the tracking of a target compound, some advances may provide for more efficient fluorescence tracking. For example, it may be that the excitation light which is provided to excite the fluorophores is lost in a reaction chamber. More specifically, in high aspect ratio chambers, such as a long cylindrical microfluidic chamber, much of the excitation light may be lost, i.e., not used to excite the fluorophores. Similarly, much of the emission light, i.e., the light emitted by the fluorophores, may not be directed towards a detection system that tracks the target compound.

Accordingly, the present specification describes a microfluidic chamber to enhance the rate of capture of the fluorescence signal. Specifically, the system includes a microfluidic chamber that receives a sample to be analyzed. The fluorescence detection system also includes an illumination system that provides the excitation light. The illumination system may provide monochromatic or polychromatic excitation light. In an example, the illumination axis is parallel to the norm of the plane of the widest wall of the microfluidic chamber. That is, a longitudinal axis of the microfluidic chamber and the illumination system may be perpendicular to one another.

An optical coupler diffuses the excitation light output from the illumination system to more evenly fill the microfluidic chamber. This excitation light excites the fluorophores in the microfluidic chamber. Responsive to excitation the fluorophores emit omni-directional light at a lower wavelength, which may be referred to as emission light. This emission light may pass through a dispersion element that spatially separates the light by wavelength and projects the dispersed light onto a detection system such that a position of light on the detection system corresponds to a particular wavelength band.

Specifically, the present specification describes a fluorescence detection system. The fluorescence detection system includes a microfluidic chamber to receive a sample containing a compound to be detected. The fluorescence detection system also includes an illumination system to provide an excitation light to excite fluorophores in the microfluidic chamber. An outcoupler of the fluorescence detection system is disposed between the illumination system and the microfluidic chamber and directs the excitation light to fill the microfluidic chamber. A detection system detects the fluorescence generated by the excitation of the fluorophores in the microfluidic chamber.

The present specification also describes a method. According to the method, a sample that includes a target compound to be detected is introduced into or generated in a microfluidic chamber. Excitation light is also introduced into the microfluidic chamber through a surface that is perpendicular to a longitudinal axis of the microfluidic chamber. The excitation light is directed through an outcoupler to fill the microfluidic chamber. The target compound is monitored by detecting, at a detection system, the fluorescence that is indicative of the target compound within the microfluidic chamber.

In another example, the fluorescence detection system includes a longitudinal microfluidic chamber to receive a sample containing a compound to be detected. The illumination system, which is perpendicular to a longitudinal axis of the microfluidic chamber, provides the excitation light to excite fluorophores in the microfluidic chamber. In this example, the illumination system includes multiple illumination elements. The fluorescence detection system also includes a lens per illumination element to direct respective excitation beams towards the microfluidic chamber. As noted above, the fluorescence detection system includes an outcoupler between the illumination system and the microfluidic chamber to diffuse the excitation light to fill the microfluidic chamber. The outcoupler is to direct excitation light to impinge on interior walls of the microfluidic chamber at angles greater than a critical angle for the microfluidic chamber and sample interface. In this example, the fluorescence detection system includes a dispersion element to spatially separate wavelengths of light emanating from excited particles and the detection system detects spatially-separated bands of fluorescence generated by the excitation of the fluorophores.

As such, the fluorescence detection system of the present specification increases the interactions between excitation light and fluorophores within a microfluidic chamber and captures an increased amount of emitted fluorescence to result in higher efficiency target compound detection. Such a system also provides a greater signal-to-noise ratio as a higher percentage of the excitation light and emission light are utilized and not lost.

Note that while the present specification describes particular types of target compounds or particles, the present systems and methods may target and eject other types of compounds and particles including beads of various materials such as metal and latex, DNA-functionalized beads, and other microspheres.

In summary, such a fluorescence detection system 1) provides a higher signal-to-noise ratio for compound detection; 2) interrogates a higher percentage of optically-active reagents due to capturing more of the excitation and emission light; 3) provides for multiplexed fluorescence detection; 4) may be implemented as a low-cost, portable, and disposable system. However, the devices disclosed herein may address other matters and deficiencies in a number of technical areas.

As used in the present specification and in the appended claims, the term “a number of” or similar language is meant to be understood broadly as any positive number including 1 to infinity.

Also, as used in the present specification and in the appended claims, the term “angle of incidence” or “incident angle” refers to an angle between a light ray incident on a surface and a line perpendicular to the surface at the point of incidence, call the normal.

Still further, as used in the present specification and in the appended claims, the term “critical angle” refers to an angle of incidence beyond which rays of light passing through a denser medium to the surface of a less dense medium are no longer refracted but totally reflected.

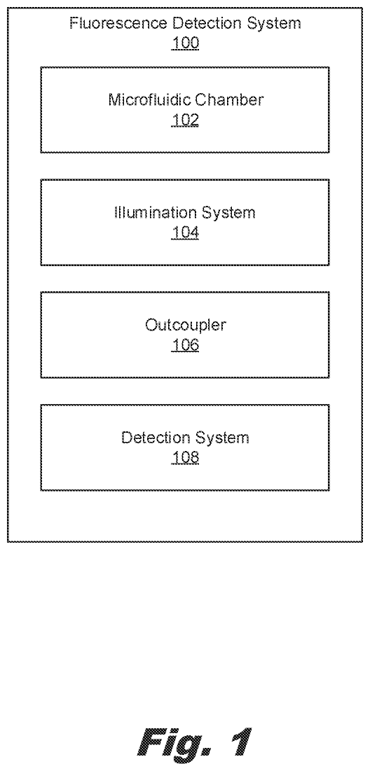

Turning now to the figures, FIG. 1 is a block diagram of a fluorescence detection system (100) with an outcoupler (106), according to an example of the principles described herein. In some examples, the fluorescence detection system (100) may be a microfluidic structure. In other words, the chamber (102) may be a microfluidic structure. A microfluidic structure is a structure of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

As described above, the fluorescence detection system (100) may be used to detect compounds and particles of a variety of types. For example, the fluorescence detection system (100) may be implemented in a life science application. Accordingly, a biological fluid may be analyzed and/or passed by the fluorescence detection system (100). In some examples, the biological fluid may include solvent or aqueous-based pharmaceutical compounds, as well as aqueous-based biomolecules including proteins, enzymes, lipids, antibiotics, mastermix, primer, DNA samples, cells, or blood components, all with or without additives, such as surfactants or glycerol. As a specific example, the fluorescence detection system (100) may be used to count cells in a particular sample fluid.

The fluorescence detection system (100) may be a part of a larger fluid ejection system. For example, the fluorescence detection system (100) may be implemented in a laboratory and may pass a sample to other components of the larger system.

The fluorescence detection system (100) includes a microfluidic chamber (102) to receive a sample containing a compound to be detected. In some examples, the microfluidic chamber (102) may be a cylindrical chamber. However, the microfluidic chamber (102) may have a variety of cross-sectional areas and configurations. For example, the microfluidic chamber (102) may have a square or rectangular cross-sectional area.

In an example, the microfluidic chamber (102) holds static fluid. That is, a sample is introduced into a microfluidic chamber (102) where it rests while being analyzed. Once the reaction or operation is complete, the microfluidic chamber (102) may be separated, for example removed and discarded, while an output is recorded by the detection system (108) and analyzed.

In another example, the microfluidic chamber (102) is a channel through which the sample is to flow. The flow through the microfluidic channel may be generated by a pump that is disposed upstream or downstream from the reaction portion of the microfluidic chamber (102). In some examples, the pump may be an integrated pump, meaning the pump is integrated into a wall of the microfluidic channel. In some examples, the pump may be an inertial pump which refers to a pump which is in an asymmetric position within the microfluidic channel. In some examples, the pump may be a thermal inkjet resistor, or a piezo-drive membrane or any other displacement device.

The fluorescence detection system (100) further includes an illumination system (104). The illumination system (104) provides the excitation light provided to the microfluidic chamber (102) to excite the fluorophores attached to a target compound such that the target compound may be tracked. The excitation light may come in a variety of wavelengths. For example, the excitation light may be ultraviolet having a wavelength of between 350 and 400 nanometers. However, excitation light with other wavelengths may be provided by the illumination system (104). For example, the excitation light may be in the infrared wavelength range.

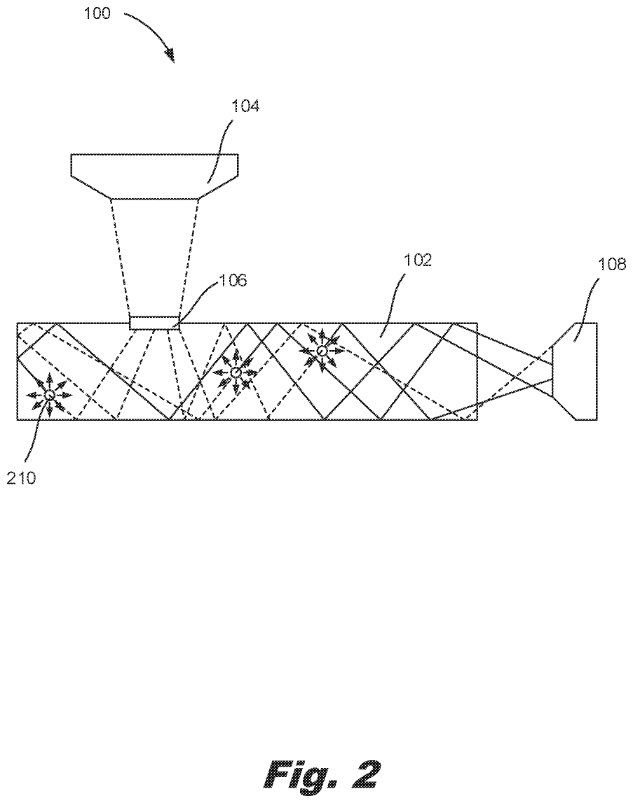

In an example, the illumination system (104) may be perpendicular to a widest surface of the microfluidic chamber (102). For example, as depicted in FIG. 2, the illumination system (104) may be perpendicular to the microfluidic chamber (102) and the detection system (108). In a specific example, the illumination system (104) may be above the microfluidic chamber (102). In such an example, the illumination system (104) may be a vertical-cavity surface-emitting laser (VCSEL) that emits the excitation light down towards the microfluidic chamber (102).

The fluorescence detection system (100) also includes an outcoupler (106) between the illumination system (104) and the microfluidic chamber (102) to direct or diffuse the excitation light to fill the microfluidic chamber (102). That is, without such an outcoupler (106), a smaller portion of the fluorophores are interrogated as excitation light is lost to the environment. Accordingly, by diffusing, i.e., spreading out, the excitation light to more angles, more excitation light remains in the microfluidic chamber (102). As more light is collected and not lost, the signal-to-noise ratio may be enhanced as more light is available to excite fluorophores.

The outcoupler (106) facilitates the capture of more excitation light based at least in part on total internal reflection within the microfluidic chamber (102). Total internal reflection is a phenomenon where light in a medium is reflected back into the medium so long as the angle of incidence of light impinging on the interface is greater than a “critical” angle. The critical angle at which total internal reflection is exhibited is based on the index of refraction of each medium at an interface between the two mediums. For example, the interface may be a microfluidic chamber (102) and ambient air interface. In an example, the microfluidic chamber (102) may be formed of an optically transparent material such as acrylic, glass, or cyclic-olefin-copolymer (COC).

A refractive index of COC is 1.53, a refractive index of the sample may be 1.33, based on it being water-based, and a refractive index of air may be 1. A fluorescence detection system (100) surrounded by air will retain light due to total internal reflection at the boundary between a COC microfluidic chamber (102) and air when the incidence angle of the light exceeds the critical angle of arcsin (1/1.53)=41°. That is, light rays having greater than a 42° incident angle at the COC/air interface will be contained in the fluorescence detection system (100). Light rays reflected from the COC/air interface that hit the COC (n=1.53)/water (n=1.33) interface at an angle greater than arcsin (1.33/1.53)=60° will be reflected from the COC/water interface and contained in the COC material. By comparison, the portion of rays reflected from the COC/air interface that impinge the COC/water interface at an incident angle lower than 60° will be returned back to sample where they may continue to excite fluorophores to generate a detectable signal. As the outcoupler (106) diffuses the light to different angles, more of the light impacts the water/COC interface at greater than this critical angle, thus increasing the amount of excitation light that remains in the microfluidic chamber (102) as compared to when no outcoupler (106) is used. In an example, when the refractive index of the microfluidic chamber (102) walls matches the water-based reagent mixture, total internal reflection of light on the wall/water interface will be minimal and all rays having an incident angle greater than arcsin (1/1.33)=49° will be contained in the microfluidic chamber (102). Example materials satisfying this condition may include poly(2,2,3,3,4,4,4-heptafluorobutyl acrylate) n=1.3770, polymethyl 3,3,3-trifluoropropyl siloxane n=1.3830, poly-dimethyl siloxane (PDMS) 1.4035 and other materials with near 1.33 refractive index value.

The outcoupler (106) may take a variety of forms. For example, the outcoupler (106) may be a lens or a lens array that spreads out the incoming excitation light into a wide plane of the microfluidic chamber (102). In another example, the outcoupler (106) may be a layer of translucent material that diffuses the excitation light. In yet another example, the outcoupler (106) may include a surface treatment, such as a roughened portion of a microfluidic chamber (102) wall. In whatever form, the outcoupler (106) diffuses the light, i.e., spreads it out among more angles, such that more excitation light hits the walls of the microfluidic chamber (102) at an angle of incidence greater than the critical angle and thus is reflected within the microfluidic chamber (102).

The fluorescence detection system (100) may also include a detection system (108) to detect the fluorescence. That is, when exposed to the excitation light, the fluorophores may fluoresce and emit a light, which emitted light may have a longer wavelength than the excitation light. For example, the emission band may have a wavelength of between 400 and 459 nanometers.

The detection system (108) may include an array of light sensitive components to detect the light emitted from the fluorophores. For example, the detection system (108) may include a charge coupled device (CCD) or a complementary metal-oxide semiconductor (CMOS) device, both of which are image sensors that detect light. In another example, the detection system (108) may be a point detector such as a photodiode.

In either example, as fluorescence emits from a target compound in the microfluidic chamber (102), it is directed towards the detection system (108). The characteristics, i.e., quantity and quality, of received fluorescence allows the fluorescence detection system (100) to track the reaction. For example, the amount of emission light that is detected may be used to indicate the degree of amplification of a target compound and/or a quantity of target compound in the microfluidic chamber (102). Accordingly, the present fluorescence detection system (100) identifies target particles in a sample by 1) increasing the amount of excitation light to excite the fluorophores and 2) increasing the rate of emitted light incidence upon the detection system (108).

FIG. 2 is a diagram of a fluorescence detection system (100) with an outcoupler (106), according to an example of the principles described herein. FIG. 2 clearly depicts the illumination system (104) and outcoupler (106) that deliver the excitation light to the microfluidic chamber (102). As noted above, the excitation light excites fluorophores (210) within the microfluidic chamber (102). The fluorophores (210) react to the excitation light and become omni-directional sources of emission light, which emission light may be a longer wavelength than the excitation light. In FIG. 2 and others, the excitation light is indicated in dashed lines whereas the emission light is indicated in solid lines. For simplicity in the figures, a few instances of excitation and emission light beams are indicated, however, thousands of beams of excitation light and emission light may be present in the fluorescence detection system (100).

In the example depicted in FIG. 2, the illumination system (104) is perpendicular to a longitudinal axis of the microfluidic chamber (102). As such, without the outcoupler (106), a larger portion of the excitation light provided by the illumination system (104) may hit the walls of the microfluidic chamber (102) at incidence angles less than the critical angle and thus may exit the microfluidic chamber (102) and not be available to quantify the target compound. However, as depicted in FIG. 2, the outcoupler (106) is to spread out the excitation light such that more of the light impacts the walls of the microfluidic chamber (102) at incidence angles greater than the critical angle, such that more is retained within the microfluidic chamber (102) where it can excite the various fluorophores (210) therein. In some examples, the interior walls of the microfluidic chamber (102) may be treated to enhance coupling and outcoupling of light. For example, the interior surfaces may be roughened such that more of the excitation light remains in the microfluidic chamber (102) and is not lost to the environment.

FIG. 2 also depicts an example where the illumination system (104) and the detection system (108) are perpendicular to one another and the detection system (108) is aligned with a longitudinal axis of the microfluidic chamber (102). That is, as the detection system (108) is parallel with the longitudinal axis of the microfluidic chamber (102), the majority of emission light may pass to the detection system (108).

As such, rather than having a small portion of the emission light being captured, which leads to signal loss and a high signal-to-noise ratio, the present fluorescence detection system (100) implements a diffusing outcoupler (106) to illuminate the entire microfluidic chamber (102) thus increasing detection efficiency and providing an enhanced signal-to-noise ratio.

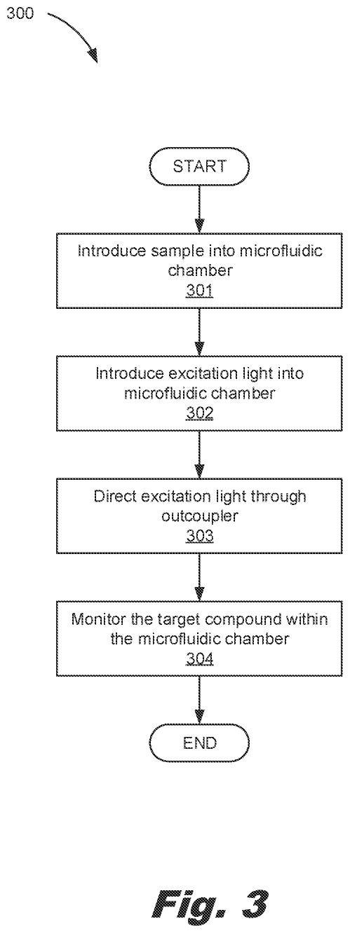

FIG. 3 is a flowchart of a method (300) for detecting a compound via a fluorescence detection system (FIG. 1, 100) with an outcoupler (FIG. 1, 106), according to an example of the principles described herein. According to an example, a sample is introduced (block 301) into the microfluidic chamber (FIG. 1, 102). As described above, the sample may be of a variety of types including a blood sample, or other biological fluid sample. In an example, the microfluidic chamber (FIG. 1, 102) is a static chamber wherein the sample is introduced (block 301) via a manual input, such as for example via a pipette. In another example, the microfluidic chamber (FIG. 1, 102) may be a channel where fluid flows continuously therethrough. In this example, the introduction (block 301) of the sample into the microfluidic channel may be via action of a pump.

According to the method (300), an excitation light is introduced (block 302) into the microfluidic chamber (FIG. 1, 102). As described above, the illumination system (FIG. 1, 104) may be perpendicular to a longitudinal axis of the microfluidic chamber (FIG. 1, 102). The excitation light is directed (block 303) through an outcoupler (FIG. 1, 106) to fill the microfluidic chamber (FIG. 1, 102). Without such an outcoupler (FIG. 1, 106), a higher percentage of excitation light may be lost to the environment. By comparison, the outcoupler (FIG. 1, 106) diffuses the excitation light such that more light beams enter the microfluidic chamber (FIG. 1, 102) at angles greater than the light guide critical angle such that the excitation light fills the microfluidic chamber (FIG. 1, 102).

The target compound is monitored (block 304) within the microfluidic chamber (FIG. 1, 102) by detecting, via the detection system (FIG. 1, 108), the fluorescence that is indicative of the target compound. That is, fluorophores (FIG. 2, 210) may be adhered to a target compound, which may be strands of DNA, antigen antibodies or any other number of biological compounds. The presence and quantity of the target compound to which the fluorophores (FIG. 2, 210) are adhered corresponds to the amount of fluorescence detected such that the fluorescence detection system (FIG. 1, 102) may quantify the presence and quantity of the target compound.

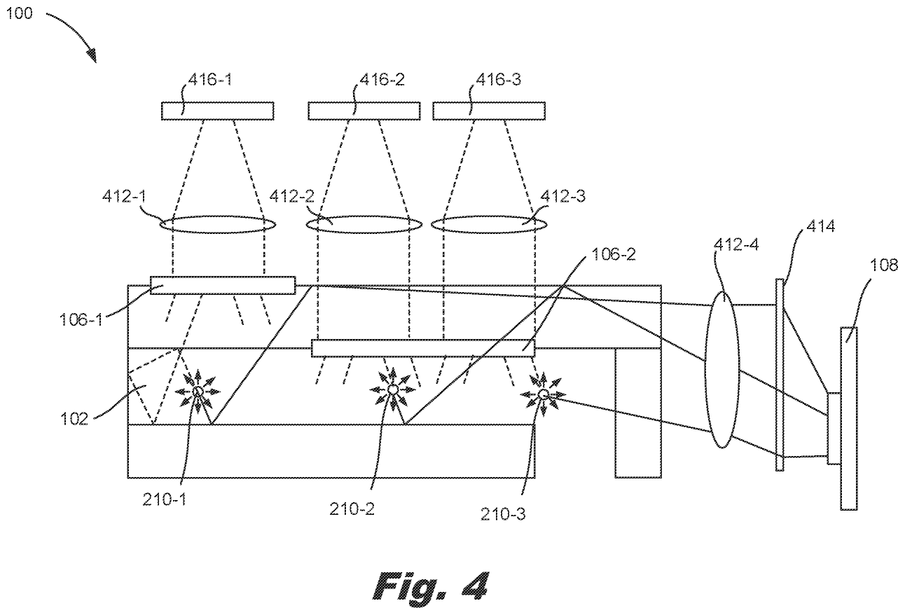

FIG. 4 is a diagram of a fluorescence detection system (100) with an outcoupler (106-1, 106-2), according to an example of the principles described herein. In the example depicted in FIG. 4, the microfluidic chamber (102) is a longitudinal chamber with an inlet at the bottom. However, in other examples, the inlet may be along a top surface of the microfluidic chamber (102). The sample may be introduced into the microfluidic chamber (102) via this inlet.

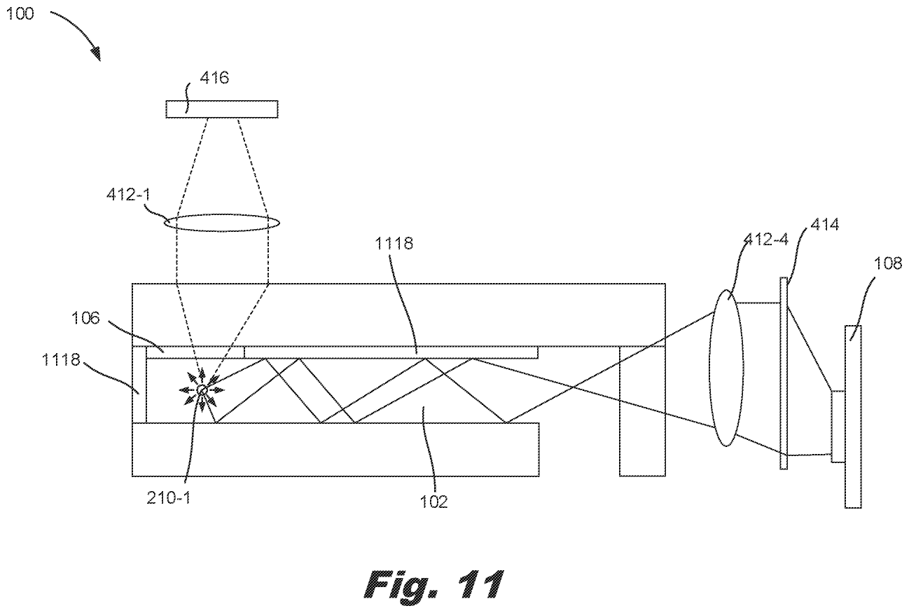

The illumination system (FIG. 1, 104) may be made up of one or multiple illumination elements. For example, as depicted in FIG. 4 and others, the illumination system (FIG. 1, 104) may include multiple illumination elements (416-1, 416-2, 416-3). By comparison, as depicted in FIG. 11 and others, the illumination system (FIG. 1, 104) may include a single illumination element (416).

Each of the different illumination elements (416) may emit light of the same wavelength or different wavelengths. The different wavelengths may excite different fluorophores (210-1, 210-2, 210-3). That is, different fluorophores (210) may be excited by light of different wavelengths. As such, a fluorescence detection system (100) with multi-wavelength illumination elements (416) may excite different fluorophores (210) and may thus be used to identify and quantify different target compounds in the sample in a multiplexing fashion.

As a particular example, the microfluidic chamber (102) may be housing a polymerase chain reaction (PCR) operation using a TaqMan probe. Different target compounds may be labeled with different dye which are excited by different excitation wavelengths. As such, the fluorescence detection system (100), by providing the different excitation wavelengths, may perform spectral multiplexing to identify different target compounds simultaneously.

The multi-illumination element (416) fluorescence detection system (100) may temporally multiplex target compound identification by sequentially turning the different illumination elements (416) on and off. As such, the fluorescence detection system (100) may identify multiple target compounds simultaneously via spectral multiplexing or sequentially via temporal multiplexing.

FIG. 4 also depicts various lenses (412-1, 412-2, 412-3, 412-4) that focus light on to respective components. For example, the fluorescence detection system (100) may include lenses (416-1, 416-2, 416-3) per illumination element (416) to direct respective excitation beams towards the microfluidic chamber (102). The fluorescence detection system (100) may also include another lens (416-4) to direct emission beams towards the detection system (108).

FIG. 4 also depicts outcouplers (106-1, 106-2) between the illumination system (FIG. 1, 104) and the microfluidic chamber (102) to diffuse the excitation light to fill the microfluidic chamber (102). As depicted in FIG. 4, the outcouplers (106-1, 106-2) may be integrated into a lid of the microfluidic chamber (102) and may be shared by multiple illumination elements (416-2, 416-3) or may be used by an individual illumination element (416-1).

FIG. 4 also depicts the detection system (108). When detecting a single fluorescence channel, the detection system (108) may include a lens (412-4) and a photodiode. However, for multiplexed fluorescence detection, the fluorescence detection system (100) may include additional components. For example, the fluorescence detection system (100) may include a dispersion element (414) to spatially separate wavelengths of emission light emanating from excited fluorophores (210).

Dispersion refers to the change in angle of refraction of different wavelengths of light. As such, the different emission wavelengths may be directed to different locations on the detection system (108). That is, different fluorophores (210) have different excitation ranges and may have different emission ranges that result from excitation. The different emission ranges may be directed to different locations on the detection system (108) surface. From that signature, the fluorescence detection system (100), or another system can determine the fluorophore (210) detected and a quantity of fluorophores (210) detected.

In another example, different fluorophores (210) may emit different emission wavelengths when exposed to a same excitation wavelength as another fluorophore (210). As such, the different emission wavelengths detected and a magnitude of those emission wavelengths, used in conjunction with the known excitation wavelength introduced to the microfluidic chamber (102), may be used to identify the fluorophore (210). As the fluorophores (210) are adhered to different target compounds, the presence and quantity of target compounds associated with each fluorophore (210) may also be determined. In this example, the detection system (110) may detect spatially-separated bands of fluorescence generated by the excitation of the fluorophores (210). That is, the detection system (108) may include components to distinguish what wavelengths impact different locations on the detection surface.

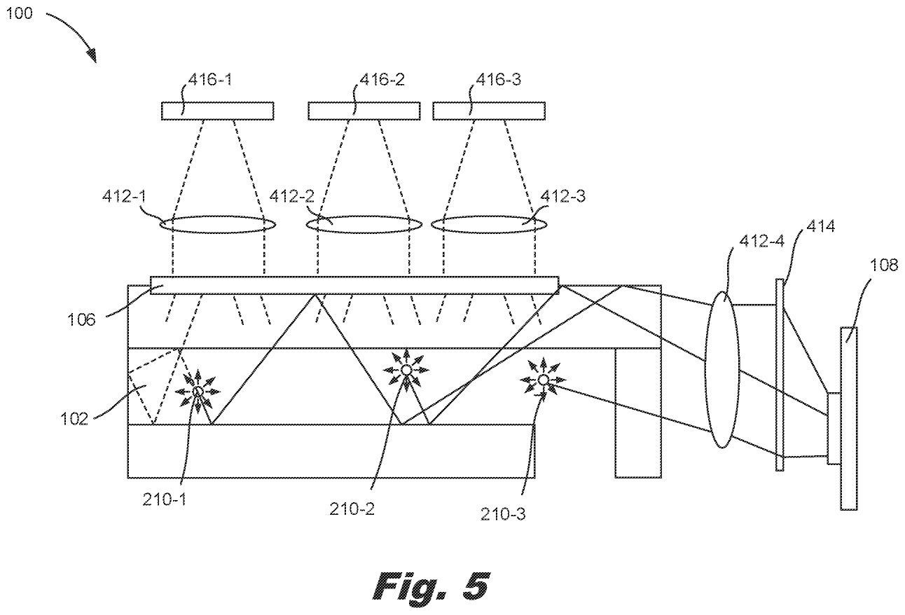

FIG. 5 is a diagram of a fluorescence detection system (100) with an outcoupler (106), according to an example of the principles described herein. In the example depicted in FIG. 5, a single outcoupler (106) is shared by the multiple illumination elements (416). As depicted in FIGS. 4 and 5, the outcoupler (106) may be formed on an interior wall of the microfluidic chamber (102) or on an exterior wall of the microfluidic chamber (102).

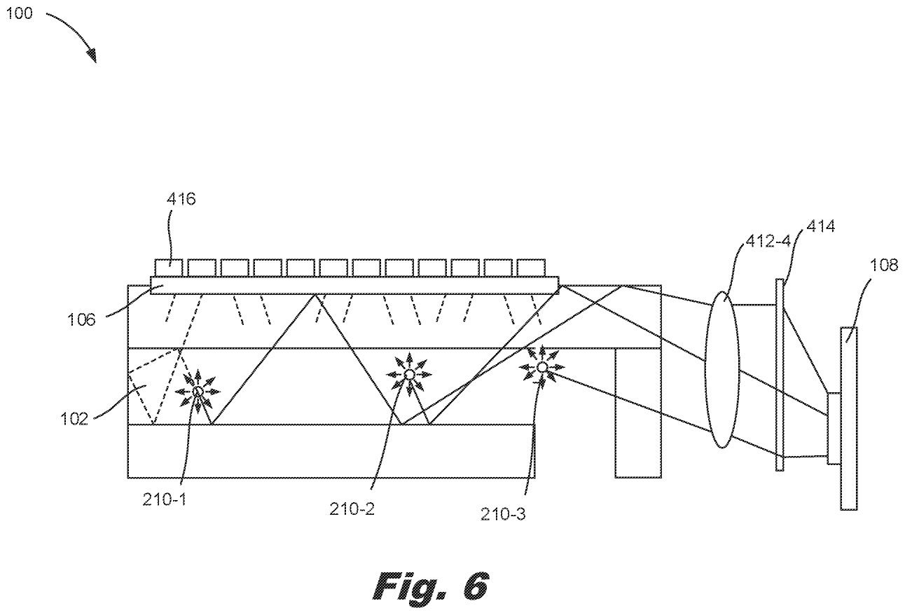

FIG. 6 is a diagram of a fluorescence detection system (100) with an outcoupler (106), according to an example of the principles described herein. In the example depicted in FIG. 6, the illumination system (FIG. 1, 104) includes light-emitting diodes (LEDs) as the illumination elements (416). For simplicity, one LED illumination element (416) is indicated with a reference number. LEDs may provide unfocused light. That is, the VCSELs and lenses depicted above may generate focused light that is diffused through an outcoupler (106). In FIG. 6 by comparison, the LEDs provide unfocused light. In the example depicted in FIG. 6, a shared outcoupler (106) is used to further diffuse the excitation light provided by the multiple LEDs. The outcoupler (106) in this example is mounted to an exterior surface of the microfluidic chamber (102).

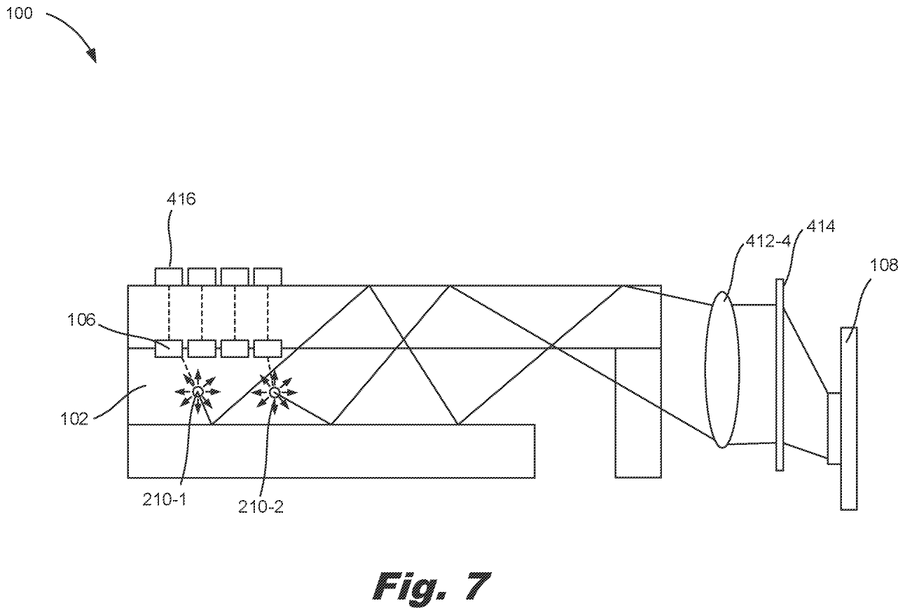

FIG. 7 is a diagram of a fluorescence detection system (100) with an outcoupler (106), according to an example of the principles described herein. In the example depicted in FIG. 7, the illumination system (FIG. 1, 104) includes light-emitting diodes (LEDs) as the illumination elements (416). However, in the example depicted in FIG. 7, there are multiple outcouplers (106), each pertaining to a respective LED illumination element (416). Moreover, in the example depicted in FIG. 7, the outcouplers (106) are formed on an interior wall of the microfluidic chamber (102). As described above, the outcoupler (106) may take a variety of forms including a surface roughness, microdots on the wall of the microfluidic chamber (102), ridges, a blazed grating, a diffraction grating, an off-axis lens, or a Fresnel lens to name a few.

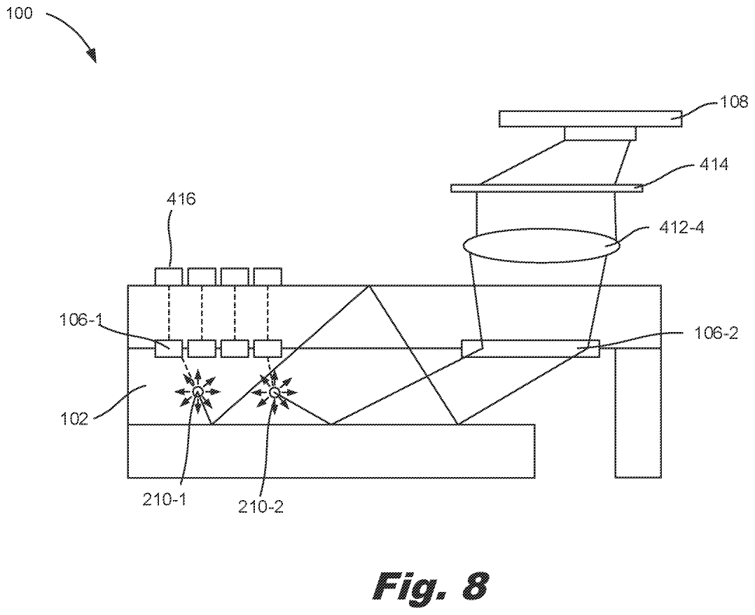

FIG. 8 is a diagram of a fluorescence detection system (100) with an outcoupler (106), according to an example of the principles described herein. In this example, in addition to the outcoupler (106-1) to diffuse excitation light incoming into the microfluidic chamber (102), the fluorescence detection system (100) includes a second outcoupler (106-2) between the microfluidic chamber (102) and the detection system (108). This second outcoupler (106-2) allows emission light from the microfluidic chamber (102) to escape into the detection system (110). The second outcoupler (106-2) directs the emission light to the detection system (108). Accordingly, the second outcoupler (106-2) ensures that more of the emission light is transmitted to the detection system (108).

FIG. 8 also depicts an example where the detection system (108), along with the illumination system (FIG. 1, 104), is perpendicular to a longitudinal axis of the microfluidic chamber (102). In the example depicted in FIG. 8, the detection system (108) and the illumination system (FIG. 1, 104) are disposed along a same side of the microfluidic chamber (102).

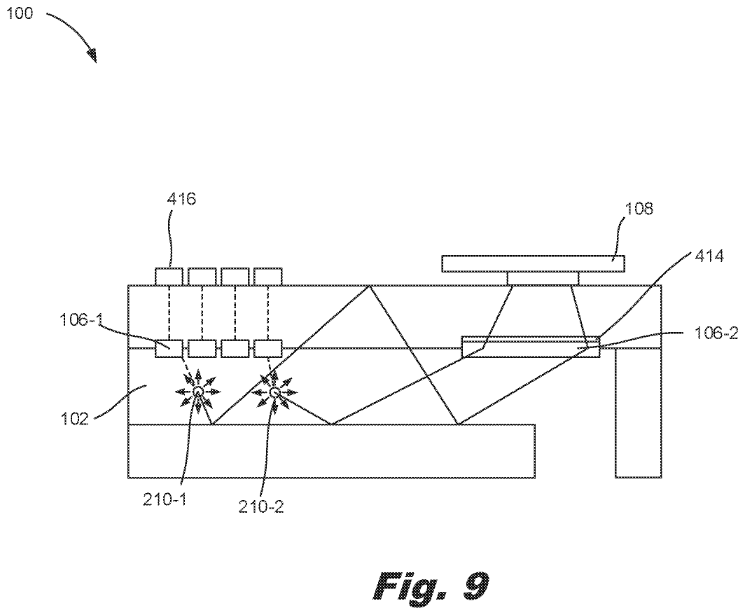

FIG. 9 is a diagram of a fluorescence detection system (100) with an outcoupler (106), according to an example of the principles described herein. In the example depicted in FIG. 9, the dispersion element (414) is integrated on the second outcoupler (106-2). In this example, the integrated dispersion element (414)/second outcoupler (106-2) is formed on an interior wall of the microfluidic chamber (102) with the detection system (108) coupled to an exterior wall of the microfluidic chamber (102).

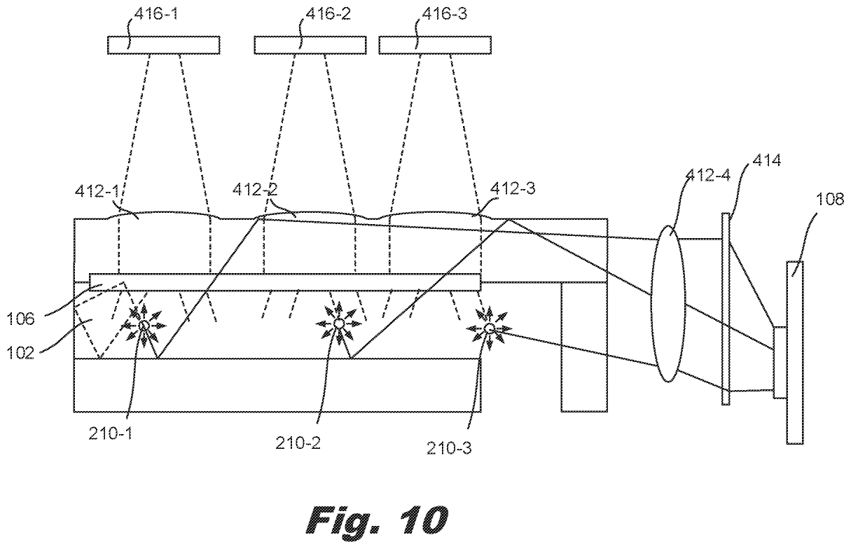

FIG. 10 is a diagram of a fluorescence detection system (100) with an outcoupler (106), according to an example of the principles described herein. In the example depicted in FIG. 10, the lenses (412-1, 412-2, 412-3) are integrated on the exterior surface of the microfluidic chamber (102). As described above, the lenses (412) may be of varying types including off-axis lenses, Fresnel lenses, diffraction lenses, and gradient-index (GRIN) lenses. Each of these lenses (412) may focus the excitation light into a location, specifically into the microfluidic chamber (102) where it may excite the fluorophores (210) therein.

FIG. 11 is a diagram of a fluorescence detection system (100) with an outcoupler (106), according to an example of the principles described herein. In the example depicted in FIG. 11, the fluorescence detection system (100) further includes a reflective coating (1118) on an interior surface of the microfluidic chamber (102) to redirect excitation light and fluorescence towards a center of the fluorescence detection system (100). That is, the difference in refractive index between the microfluidic chamber (102) volume and walls of the microfluidic chamber (102), which may be formed of an optically transparent material such as glass, acrylic, or COC, may induce total internal reflection for those beams of light that have an angle of incidence greater than the critical angle. Due to action of the outcoupler (106), a greater portion of the light remains in the microfluidic chamber (102). The fluorescence detection system (100) with outcouplers (106) may collect around 30% of generated fluorescence. However, excitation light and fluorescence may still escape and be lost from the excitation and detection operations as some of the light may still impact the interior walls of the microfluidic chamber (102) at angles less than the critical angle. Accordingly, the reflective coating (1118) may reflect excitation light and fluorescence, even those that impact the coating at less than the critical angle, towards the interior of the microfluidic chamber (102) such that they may ultimately be directed to the detection system (108). Such a system may collect a majority of the generated fluorescence.

The reflective coating (1118) may take a variety of forms. For example, the reflective coating (1118) may be a mirror that reflects light. In another example, the reflective coating (1118) is a reflective diffuser, that in addition to reflecting the light into the microfluidic chamber (102), also spreads out, or diffuses, the light to further enhance excitation and detection.

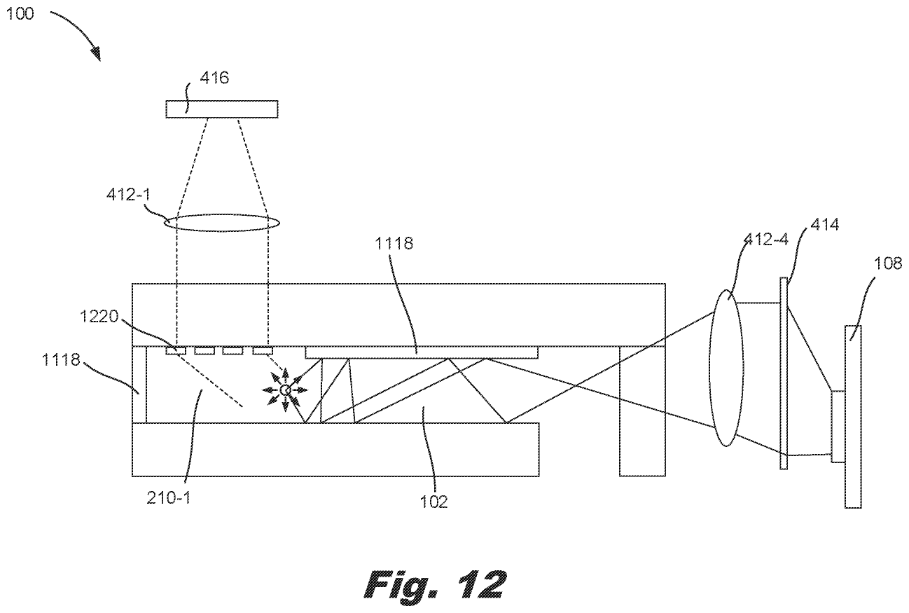

FIG. 12 is a diagram of a fluorescence detection system (100) with an outcoupler (FIG. 1, 106), according to an example of the principles described herein. In the example depicted in FIG. 12, the outcoupler (FIG. 1, 106) is a blazed grating (1220). A blazed grating (1220) is a surface feature wherein a series of ridges are etched into the surface. A blazed grating (1220) provides greater directionality to the incoming excitation light. That is, the ridges of the blazed grating (1220) surface may be angled such that incoming excitation light is directed towards the detection system (108).

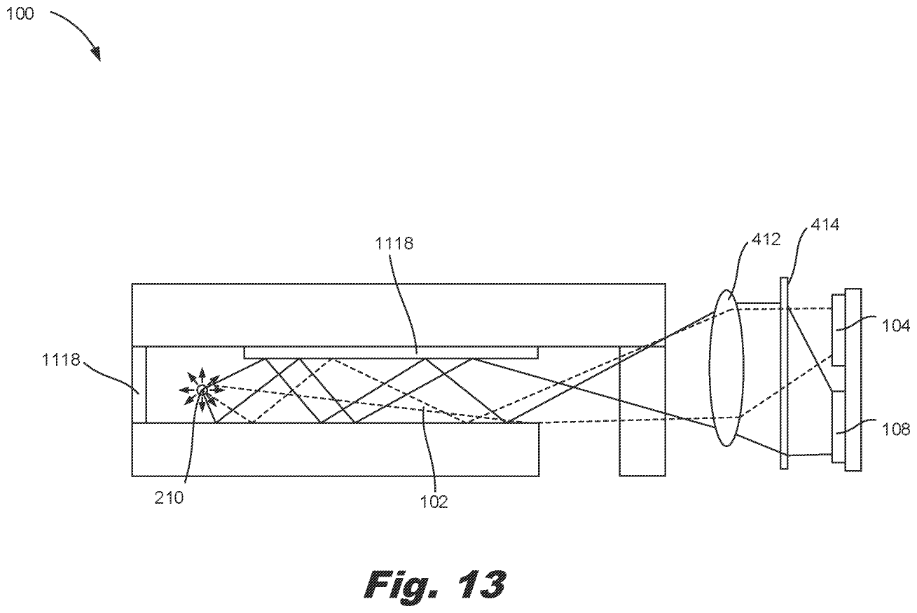

FIG. 13 is a diagram of a fluorescence detection system (100) with an outcoupler (FIG. 1, 106), according to an example of the principles described herein. In the example depicted in FIG. 13, the illumination system (104) and the detection system (108) are disposed on the same substrate. In this example, the dispersion element (414) may act as the outcoupler (FIG. 1, 106) to direct the excitation light. In this example, the illumination may be monochromatic. As such, the excitation light passes through the dispersion element (414) where it spreads and is directed into the microfluidic chamber (102) through the lens (412). Once in the microfluidic chamber (102), the excitation light excites the fluorophores (210) which generate emission light. After reflecting off the walls of the microfluidic chamber (102) due to total internal reflection and/or reflection off the reflective coating (1118), the emission light returns through the lens (412) and dispersion element (414) where it is spectrally separated and directed to the detection system (108). In this example, losses due to apertures in the reflective coating (118) may be reduced.

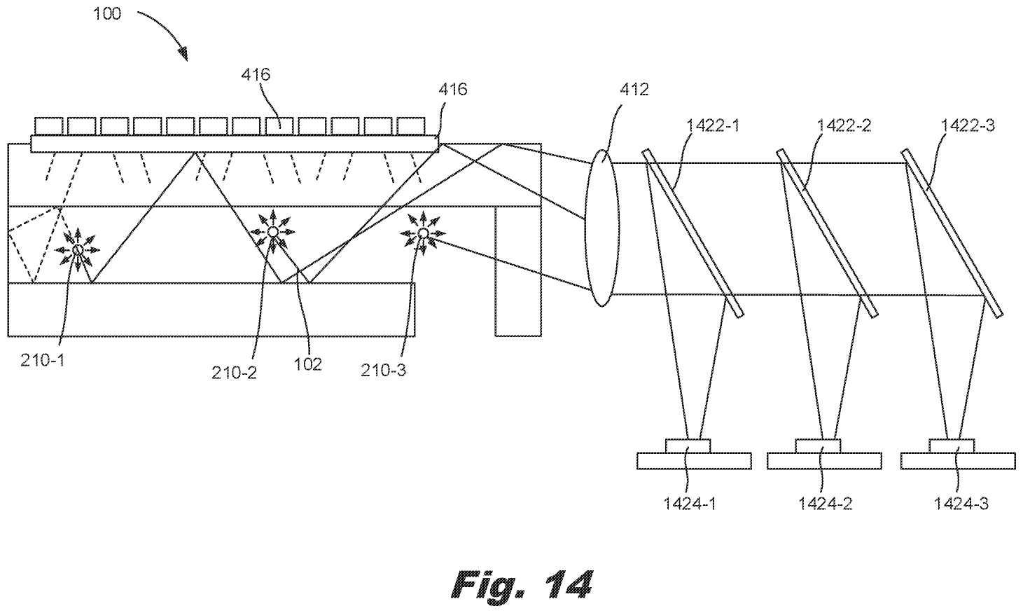

FIG. 14 is a diagram of a fluorescence detection system (100) with an outcoupler (106), according to an example of the principles described herein. As described above, it may be the case that different illumination elements (416) emit light in different wavelength bands thus exciting different fluorophores (210) which then generate emission light in different wavelength bands. In another example, it may be the case that different fluorophores (210) generate emission light in different wavelength bands, even when exposed to the same excitation wavelength band. Accordingly, the detection system (FIG. 1, 108) is to accommodate different received emission light wavelengths and associate those different wavelength ranges with different fluorophores/target compounds.

FIG. 14 depicts an example where different emission light wavelength bands are separated via dichroic filters (1422-1, 1422-2, 1422-3). A dichroic filter (1422) allows certain light to pass through while reflecting others. For example, a first dichroic filter (1422-1) may allow certain light to pass, i.e., towards the other dichroic filters (1422-2, 1422-3), while re-directing light in a first dichroic filter range towards a first detection element (1424-1). Of the remaining light ranges, the second dichroic filter (1422-2) may allow a portion of the light to pass, i.e., towards the third dichroic filter (1422-3), while re-directing light in a second dichroic filter range towards a second detection element (1424-2). The third dichroic filter (1422-3) may allow a portion of the light to pass, i.e., that light which is outside of the emission light range, for example that is excitation light, while re-directing light in a third dichroic filter range towards a third detection element (1424-3). As with the above examples, the emission light is thus spectrally separated for analysis.

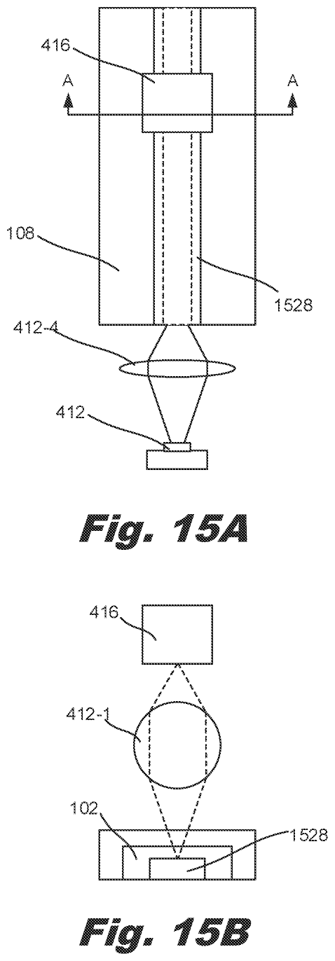

FIGS. 15A and 15B are diagrams of a fluorescence detection system (100) with an outcoupler (FIG. 1, 106), according to an example of the principles described herein. Specifically, FIG. 15A is a top view and FIG. 15B is a cross-sectional view taken along the line A-A in FIG. 15A. In some examples, the excitation beam may be a line-shaped excitation beam. That is, rather than relying on multiple illumination elements (416) to illuminate an entire length of the microfluidic chamber (102), a single illumination element (416) may be used. In this example, the excitation light is passed through a lens (412-1) that generates a line-shaped beam from a point source. As such the lens (412-1) may receive the excitation light from the illumination element (416) and reshape it into a generally line-shaped beam spanning a length of the microfluidic chamber (102). In this example, the lens (412-1) may take a variety of forms to generate the line-shaped excitation beam. For example, the lens (412-1) may be a Powell lens, cylindrical lens, GRIN lens, or a cylindrical metalens to fan out collimated light beams in a single direction. As used in the present specification and in the appended claims, a meta lens is a lens made from a surface with patterned nanostructures. This array of patterned nanostructures may change the light path and so shape a wavefront. Accordingly, the wavefront may be shaped so as to spread the light in one direction of the lens. As a particular example, the lens (412-1) may be a round prism with a chevron-shaped roof line. FIGS. 15A and 15B also depict a heater (1528) that may be used in reactions occurring within the microfluidic chamber (102).

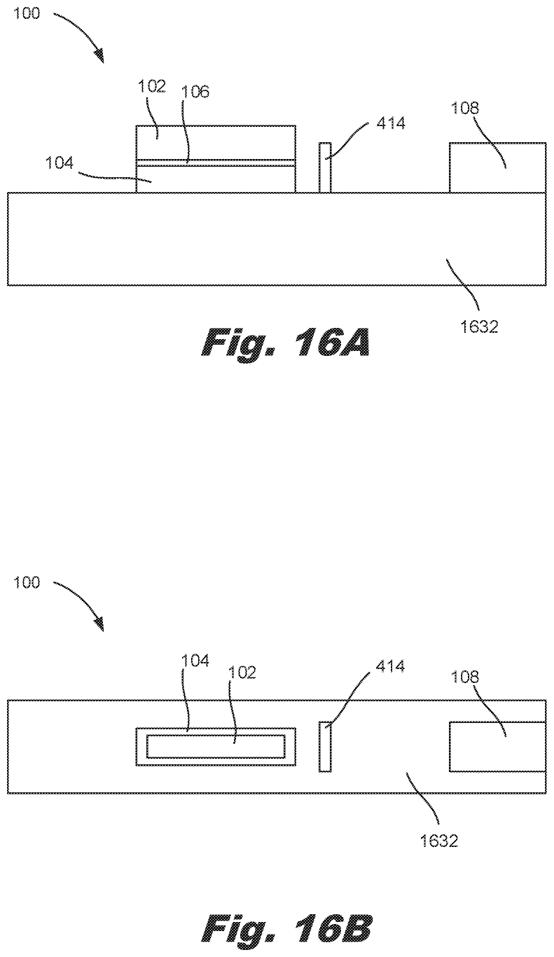

FIGS. 16A and 16B are diagrams of a fluorescence detection system (100) with an outcoupler (106), according to an example of the principles described herein. Specifically, FIG. 16A is a side view of the fluorescence detection system (100) and FIG. 16B is a top view of the fluorescence detection system (100).

In this example, the fluorescence detection system (100) further includes a substrate (1632) on which the microfluidic chamber (102), illumination system (104), lens (414), and detection system (108) are disposed. For example, the substrate (1632) may be a silicon substrate such as a printed circuit board, glass or an epoxy mold compound or other suitable substrate.

In such an example, a portion of the components may be detachable from other components. For example, the illumination system (104) and the detection system (108) may be attached to the substrate (1632) and may be collinear with a longitudinal axis of the microfluidic chamber (102). In this example, the microfluidic chamber (102) may be separable from the illumination system (104). In such an example, the microfluidic chamber (102) may be viewed as a disposable cassette. For example, the sample may be loaded into a microfluidic chamber (102), which microfluidic chamber (102) may be transported and placed on top of the illumination system (104) for analysis. Following analysis, the microfluidic chamber (102) may be discarded.

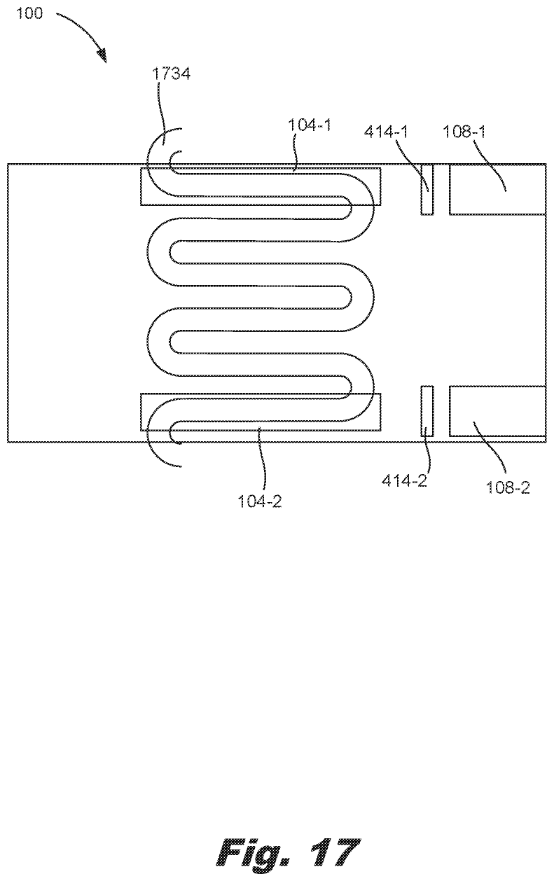

FIG. 17 is a diagram of a fluorescence detection system (100) with an outcoupler (FIG. 1, 106), according to an example of the principles described herein. In this example, the microfluidic chamber (FIG. 1, 102) is a microfluidic channel (1734). In this example, the sample is pumped through the microfluidic channel (1734) as a continuous flow. That is, rather than monitoring a static sample, the sample may be continuously pumped while the fluorescence detection system (100) detects target compounds in the sample. In this example, the microfluidic channel (1028) may be coupled at one end to a reservoir and an outlet at the other end.

As depicted in FIG. 17, the fluorescence detection system (100) may include multiple instances of elements of different components. For example, the fluorescence detection system (100) may include multiple illumination systems (104-1, 104-2), lenses (414-1, 414-2), and detection systems (108-1, 108-2) which may emit, filter, and detect the same wavelengths of light, for example to verify the measurements of other elements, to provide a time-dependent indication of the target compound.

In another example, the elements may emit, filter, or detect different wavelengths in order to track and detect different target compounds. That is, different fluorophores may be excited by different wavelengths of light and may also emit different wavelengths of fluorescence. Accordingly, components with different operating ranges may be able to detect different compounds within a single sample, thus providing multiplexed compound detection in a sample.

In summary, such a fluorescence detection system 1) provides a higher signal to noise ratio for compound detection; 2) interrogates a higher percentage of optically-active reagents due to capturing more of the excitation and emission light; 3) provides for multiplexed fluorescence detection; 4) may be implemented as a low-cost, portable, and disposable system. However, the devices disclosed herein may address other matters and deficiencies in a number of technical areas.

1. A fluorescence detection system, comprising:
a microfluidic chamber to receive a sample containing a compound to be detected;
an illumination system to provide an excitation light to excite fluorophores in the microfluidic chamber;
an outcoupler between the illumination system and the microfluidic chamber to direct the excitation light to fill the microfluidic chamber; and
a detection system to detect fluorescence generated by the excitation of the fluorophores in the microfluidic chamber.

2. The particle detection system of claim 1, wherein the illumination system is perpendicular to a longitudinal axis of the microfluidic chamber.

3. The fluorescence detection system of claim 1, wherein:
the illumination system and detection system are perpendicular to one another; and
the detection system is aligned with a longitudinal axis of the microfluidic chamber.

4. The fluorescence detection system of claim 1, wherein the illumination system comprises multiple illumination elements to emit excitation light in different wavelength ranges.

5. The fluorescence detection system of claim 1, further comprising a second outcoupler between the microfluidic chamber and the detection system.

6. The fluorescence detection system of claim 5, further comprising a dispersion element integrated with the second outcoupler, the dispersion element to spatially separate wavelengths of emission light emanating from excited fluorophores.

7. The fluorescence detection system of claim 1, further comprising a reflective coating on an interior surface of the microfluidic chamber to redirect excitation light and emission light towards a center of the fluorescence detection system.

8. The fluorescence detection system of claim 1, further comprising a substrate, wherein:
the illumination system and detection system are attached to the substrate; and
the microfluidic chamber is separable from the illumination system.

9. The fluorescence detection system of claim 1, further comprising a substrate, wherein:
the illumination system and detection system are attached to the substrate; and
the illumination system and detection system are collinear with a longitudinal axis of the microfluidic chamber.

10. A method, comprising:
introducing a sample comprising a target compound to be detected into a microfluidic chamber;
introducing an excitation light into the microfluidic chamber through a surface that is perpendicular to a longitudinal axis of the microfluidic chamber;
directing the excitation light through an outcoupler to fill the microfluidic chamber; and
monitoring the target compound within the microfluidic chamber by detecting, at a detection system, the fluorescence that is indicative of the target compound within the microfluidic chamber.

11. The method of claim 10, wherein:
the microfluidic reaction chamber is a microfluidic channel; and
the method further comprises introducing a continuous flow of the sample through the microfluidic channel.

12. The method of claim 10, further comprising generating a line-shaped excitation light beam.

13. A fluorescence detection system, comprising:
a longitudinal microfluidic chamber to receive a sample containing a compound to be detected;
an illumination system, perpendicular to a longitudinal axis of the microfluidic chamber to provide an excitation light to excite fluorophores in the microfluidic chamber, wherein the illumination system comprises multiple illumination elements;
a lens, per illumination element, to direct respective excitation beams towards the microfluidic chamber;
an outcoupler between the illumination system and the microfluidic chamber to direct the excitation light to fill the microfluidic chamber, wherein the outcoupler is to direct excitation light to impinge on interior walls of the microfluidic chamber at angles greater than a critical angle for the microfluidic chamber and sample interface;
a dispersion element to spatially separate wavelengths of light emanating from excited fluorophores; and
a detection system to detect spatially-separated bands of fluorescence generated by the excitation of the fluorophores.

14. The fluorescence detection system of claim 13, wherein:
the detection system is perpendicular to a longitudinal axis of the microfluidic chamber; and
the detection system and illumination system are disposed along a same side of the microfluidic chamber.

15. The fluorescence detection system of claim 13, wherein the lenses are integrated on an exterior surface of the longitudinal microfluidic chamber.
